(19) United States
(12) Patent Application Publication
(10) Pub. No.: US 2010/0274599 A1
(43) Pub. Date: Oct. 28, 2010

(54) METHOD AND SYSTEM FOR MONITORING USAGE POLICY BY MANIPULATING USAGE GOVERNANCE LOGS

(75) Inventor: Matthew DeRoller, Webster, NY (US)

Correspondence Address: Xerox Corporation (CDFS), 445 Broad Hollow Rd.-Suite 420, Melville, NY, 11747, US

(73) Assignee: Xerox Corporation, Norwalk, CT (US)

(21) Appl. No.: 12/428,862

(22) Filed: Apr. 23, 2009

(51) Int. Cl. G06Q 10/00

(52) U.S. Cl. 705/7

(57) ABSTRACT

A method and system suitable for monitoring usage behaviors of a plurality of users, the usage behaviors related to a plurality of multifunction devices (MFDs), including a storage station for storing information related to a plurality of attempted tasks transmitted to the plurality of MFDs by the plurality of users; and a processor module for analyzing, at selected time intervals, the information related to the plurality of attempted tasks for user compliance to evaluate one or more preset rules based on the user compliance, the analyzing including automatic print governance alerting, where one or more alerts are configured to be triggered for any of the one or more preset rules.

### BACKGROUND

1. Field of the Related Art

The present disclosure relates to print management systems, and more particularly, to a method and system for monitoring usage behaviors of a plurality of users and analyzing user compliance for evaluation of one or more preset rules and/or policies.

2. Background of the Related Art

Organizations such as business enterprises, educational, government, and medical institutions often have large expenditures relating to printing paper documents, and often experience difficulty with control over the flow of information by printed documents, as the print volume of multifunctional systems has risen sharply in recent years. In the printing context, the main issue is the cost-per-page of high-performance multifunctional systems. In most entities, attempts to control high-performance multifunctional system print volumes and the associated cost increases have been largely unsuccessful. To make matters worse, potential environmental issues with high-performance multifunctional systems are becoming a concern. Resolving these issues is a top priority among IT professionals and the corporations that employ multifunctional systems for their business requirements.

Furthermore, photocopiers continue to advance in terms of the functionality and flexibility they provide. For example, rather than being stand alone machines as they once were, many copy machines now have digital processing capabilities and network interfaces which allow them to be connected to a computer network. This provides a variety of advantages. Once such advantage is that the copiers may be used as multi-function devices (MFDS) not only for performing traditional photocopying, but also for printing documents generated by computers connected to the network. Moreover, where copiers are connected to a computer network, it becomes possible to collect status and usage information from the computers remotely via a network server or other network terminal. Another advantageous aspect of having networked copiers or MFDs is the ability to monitor and account for the usage of such MFDs.

In general, a MFD operates as a plurality of different imaging devices, including, but not limited to, a printer, copier, fax machine, and/or scanner. In recent years the basic office copier has evolved into what can be referred to as a MFD. With digital technology, a machine with the basic outward appearance of a traditional copier can perform at least the additional functions of printing documents submitted in digital form over a network, sending and receiving messages via facsimile, recording hard-copy original images in digital form and sending the resulting data over a network, such as in electronic mail and/or recording hard-copy original images in digital form on a compact disc or equivalent medium.

In the area of digital printing and copying, there has been a growth in demand for MFDs. Such MFD devices may assume the form of an arrangement in which a single print engine (e.g., xerographic or thermal ink jet print engine) is coupled with a plurality of different image input devices (or “services”), with such devices being adapted to produce image related information for use by the printer or transmitted over a network. The image related information, in one example, could have its origin in video facsimile signals, microfilm, data processing information, light scanning platens for full size documents, aperture cards, and microfiche. MFDs provide a broader range of functionality than traditional single-function devices, such as dedicated printers, copiers, and scanners. As a result, because of their network transmission capabilities combined with their functionality, it would be useful to provide for a methodology for monitoring usage behaviors of a plurality of users and analyzing user compliance for evaluation of one or more preset rules and/or policies

Thus, as office printer or MFD manufacturers market more printing, copying, scanning, and/or faxing capabilities in the enterprise office environment, customers desire assurances from their managed output service providers that access to MFDs with such capabilities is being tracked and controlled for user compliance with preestablished rules and/or policies. Additionally, customers' desire insight into who is generating black and white/color volume, who is accessing unauthorized services, who is accessing several services and what kind of services, etc. so that overages can be charged back to individuals or departments. Moreover, customers desire governance/control over who accesses one or more functions pertaining to one or more MFDs. Thus, it is desirable that output management solutions are managed correctly to ensure effective governance and to ensure that rules and/or policies are adhered to by the plurality of users and that the rules and/or policies are effective.

However, proactively detecting issues related to governance rules and/or policies can be problematic and time consuming for system administrators of output management solutions. Ensuring smooth deployment of an output management solution at a customer environment is required to maintain user productivity, while meeting the customers' service level agreement expectations. This can be a difficult process to manage, especially when print governance policies and/or rules are being applied. Over time, users should become conditioned to the new print governance rules and/or polices and modify their behavior accordingly. Nevertheless, the desired trend is less policies and/or rules being enforced because users learn to modify their print behavior (e.g., options they choose when printing, or devices they choose). However, this is often not the case with problematic policies and/or rules. In addition, the governance polices and/or rules put in place may require modification. On the other hand, determining which policies and/or rules to modify is difficult. Therefore, the enforcement of rules and/or polices related to a plurality of MFDs can be a difficult and time-consuming process.

In summary, the current process for conditioning user printing behavior and modifying governance policies and/or rules is to review data collected for the End-Of-Month (EOM) billing cycle. It's during this time that print job tracking records are reviewed for overages or department-level usage. It's also when help desk activity is reviewed for impact that print governance policies and/or rules are having on the user printing environment. For example, the managed print services provider reviews help desk tickets related to user printing looking for impact print governance or break/fix management had on user printing productivity. Nevertheless, this EOM review process is a manual activity and by this time it's too late to proactively detect issues with rules and/or policies and correct them.

Thus, current systems lack the capability to effectively analyze, for example, print job data on a real-time basis for user compliance with pre-established rules and/or policies. The present disclosure is intended to overcome the drawbacks of other methods by providing for an effective print/scan/copy/fax job tracking system and method for monitoring usage behaviors of a plurality of users and analyzing user compliance for evaluation of one or more preset/predetermined/pre-established rules and/or policies.

### SUMMARY

The present disclosure provides a system suitable for monitoring usage behaviors of a plurality of users, the usage behaviors related to a plurality of multifunction devices (MFDs), the system including a storage station for storing information related to a plurality of attempted tasks transmitted to the plurality of MFDs by the plurality of users; and a processor module for analyzing the information related to the plurality of attempted tasks for user compliance to evaluate one or more preset rules based on the user compliance, the analyzing including automatic print governance alerting, where one or more alerts are configured to be triggered for any of the one or more preset rules.

The present disclosure also provides a method suitable for monitoring usage behaviors of a plurality of users, the usage behaviors related to a plurality of multifunction devices (MFDs), the method including transmitting a plurality of attempted tasks to the plurality of MFDs from the plurality of users; storing information related to the plurality of attempted tasks via a storage station; analyzing the information related to the plurality of attempted tasks for user compliance via a processor module; and evaluating one or more preset rules based on the user compliance, the analyzing including automatic print governance alerting, where one or more alerts are configured to be triggered for any of the one or more preset rules.

The present disclosure also provides a computer-readable medium which stores programmable instructions configured for being executed by at least one processor for performing the methods described herein according to the present disclosure. The computer-readable medium can include flash memory, CD-ROM, a hard drive, etc.

### BRIEF DESCRIPTION OF THE DRAWINGS

Various embodiments of the present disclosure will be described herein below with reference to the figures wherein:

FIG. 1 is a schematic diagram of a print policy log, in accordance with the present disclosure;

FIG. 2 is a schematic diagram of a print log for a specific user, in accordance with the present disclosure;

FIG. 3 shows a schematic diagram of a print policy log submitted to a system administrator for evaluation, in accordance with the present disclosure;

FIG. 4 is a schematic diagram of a conditioned print behavior plot, in accordance with the present disclosure;

FIG. 5 is a schematic diagram of a unconditioned print behavior plot, in accordance with the present disclosure;

FIG. 6 is a flowchart illustrating a method for monitoring usage behaviors of a plurality of users and analyzing user compliance for evaluation of one or more preset rules and/or policies, in accordance with the present disclosure;

FIG. 7 is a screen displaying one or more alerts next to one or more rules and/or policies, in accordance with the present disclosure;

FIG. 8A is an alert editing screen, in accordance with the present disclosure; and

FIG. 8B is a business hours policy alert screen, in accordance with the present disclosure.

### DETAILED DESCRIPTION

The present disclosure proposes leveraging print governance logs (e.g., the historical logs that show what policies and/or rules were enforced) to do, for example, two things: (1) condition user printing behavior, where users are sent a daily/weekly/monthly report detailing print governance activity tied to their user ID or login, and (2) propose print governance policy and/or rule changes to the system administrator, where system administrators review a graph for each policy and/or rule showing print governance enforcement over a given time period.

The present disclosure further proposes providing a network and related methods, which generate MFD usage information that may be analyzed to determine a more efficient allocation of MFD resources and, consequently, promote more responsible use and a better understanding of printing costs related to the plurality of MFDs. Print assessments can uncover many costs associated with printing and output and they reveal how customers are using their office equipment. One goal is to tailor an entity's printing and output solution to its specific needs by having users comply with preset/predetermined rules and/or policies. As a result, by performing a print/output assessment, and by enforcing rules and/or policies, an entity (such as a company or organization) may be able to more effectively monitor and modify rules and/or policies on a real-time and/or periodic basis.

Additionally, the printing system of the exemplary embodiments of the present disclosure measure and generate an analysis of the customer's device fleet (such as MFDs) performance by using built-in reporting, tracking, analyzing, and updating modules. The resulting data enables the creation of service strategies and billing models tailored to an entity's goals. The copier and printer cost evaluation can be measured by using various criteria such as user, department, project, and client or machine number. All print jobs can be classified by volume and user and it is also possible to correctly differentiate between color and black and white jobs, paper formats, and/or paper types. As a result, this is a dynamic system because it is updated selectively, dynamically, and automatically in accordance with input received from the users related to their usage behaviors in accordance with pre-established rules and/or polices.

The present disclosure further proposes a print management method and system. In general, the rules-based system components of the present disclosure may create, test and modify rules, track all print usage and the application of rules and/or policies, and user responses thereto, and/or provide reports on print usage and behavior modification to a variety of authorized users (such as system administrators). The present disclosure further enables efficient gathering of data related to the plurality of users and/or the plurality of MFDs by aiding a system administrator in determining whether the plurality of users are adhering to or abiding by the preset or pre-established rules and/or policies. As a result, the plurality of users are empowered and educated to better understand alternatives when using a plurality of MFDs.

Prior to describing the present disclosure in further detail, it will first be helpful to define various terms that will be used throughout the following discussion. For example:

The term “print” is overloaded to mean sending the document to the printer through any one of a multitude of ways. Moreover, the term “printer” can refer to any device that accepts text and graphic output from any type of computing device and transfers the information to any printable medium. A “printer” can refer to any type of xerographic, solid ink, liquid ink, cut sheet or web-based device used to print onto a wide array of printable media. The term “printer” as used herein encompasses any apparatus, such as a digital copier, bookmaking machine, facsimile machine, multi-function machine, etc. which performs a print outputting function for any purpose.

MFDs disclosed herein include both those that are “connected” and those that are “unconnected.” An “unconnected” MFD does not have access to a network (e.g., the Internet). A “connected” MFD is normally connected via an Ethernet card or the like to a network. In the present embodiments, the MFD may be an unconnected MFD that is in operative communication with a wireless device, the wireless device being able to access a network. A connection between the multifunctional device and the wireless device is made through a two-way communication channel located on the multifunctional device.

The term “MFD” can refer to any machine that connects to either a computing device and/or network and performs one or more of the following functions: print, scan, copy, and/or fax. Digital copiers, fax machines, printers, and scanner combinations are all examples of MFDs. The term “MFD” can further refer to any hardware that combines several functions in one unit. For instance, an MFD can be a standalone printer or any type of standalone machine/device/apparatus/component. For example, an MFD can be one or more personal computers (PCs), a standalone printer, a standalone scanner, a mobile phone, an MP3 player, audio electronics, video electronics, GPS systems, televisions, recording and/or reproducing media (such as CDs, DVDs, camcorders, cameras, etc.) or any other type of consumer or non-consumer analog and/or digital electronics. Such consumer and/or non-consumer electronics can apply in any type of entertainment, communications, home, and/or office capacity. Thus, the term “MFDs” can refer to any type of electronics suitable for use with a circuit board and intended to be used by a plurality of individuals for a variety of purposes.

The term “storage” can refer to data storage. “Data storage” can refer to any article or material (e.g., a hard disk) from which information is capable of being reproduced, with or without the aid of any other article or device. “Data storage” can refer to the holding of data in an electromagnetic form for access by a computer processor. Primary storage is data in random access memory (RAM) and other “built-in” devices. Secondary storage is data on hard disk, tapes, and other external devices. “Data storage” can also refer to the permanent holding place for digital data, until purposely erased. “Storage” implies a repository that retains its content without power. “Storage” mostly means magnetic disks, magnetic tapes and optical discs (CD, DVD, etc.). “Storage” may also refer to non-volatile memory chips such as flash, Read-Only memory (ROM) and/or Electrically Erasable Programmable Read-Only Memory (EEPROM).

As used herein, “print job” is not limited to a particular electronic format, such a bitmap, but can include any suitable format including PDF, word processor formats, rich text (RTF), etc., as will be appreciated by those skilled in the art.

The term “task” refers to a print, scan, copy, and/or fax job or any type of function that may be performed by an MFD. The term “task” may also refer to an execution path through address space, such as a set of program instructions that are loaded in a data storage means. The term “task” may also refer to a basic unit of programming that an operating system controls and depending on how the operating system defines a task in its design, this unit of programming may be an entire program or each successive invocation of a program.

The term “output governance rules” refers to a principle or condition that governs an output task related to a plurality of MFDs.

The term “module” may refer to a self-contained component (unit or item) that is used in combination with other components and/or a separate and distinct unit of hardware or software that may be used as a component in a system, such as a printing system including a plurality of MFDs. The term “module” may also refer to a self-contained assembly of electronic components and circuitry, such as a stage in a computer that is installed as a unit.

The term “rule” may refer to a principle and/or condition where one or more MFDs are caused to perform one or more requested tasks according to a preset /predetermined default mode as a result of the principles and/or conditions when the task is requested. The term “rule” may also refer to a prescribed guide for action for the plurality of MFDs. Examples of rules may include, but are not limited to: allow only certain users to print in color, allow only certain users to print black and white, allow only certain users to make more than a preset amount of copies per printer, allow only certain users to scan or fax or copy, allow only certain users to print graphics, allow most users to print text, allow only certain users to print information from the Internet, allow only certain users to print single sided, allow only certain users to print unlimited information, allow a set amount of print jobs from a terminal to one MFD or to a plurality of MFDs, allow for switching of MFDs when a quota has been reached, allow for denial of access to any of the MFDs, allow for counting the number of pages printed from each terminal to any permissible MFD, etc.

The term “analyze” may refer to determining the elements or essential features or functions or processes of a plurality of MFDs and/or to subject the plurality of MFDs to computational processing. The term “analyze” may further refer to tracking data and/or collecting data and/or manipulating data and/or examining data and/or updating data on a real-time basis in an automatic manner and/or a selective manner and/or manual manner.

The term “behavior” may refer to any type of responses or actions received from one or more users interacting with one or more MFDs and/or any type of pattern of actions. The term “behavior” may also refer to any type of process of gathering/collecting information about an individual's behavior when interacting with one or more MFDs.

Embodiments will be described below while referencing the accompanying figures. The accompanying figures are merely examples and are not intended to limit the scope of the present disclosure.

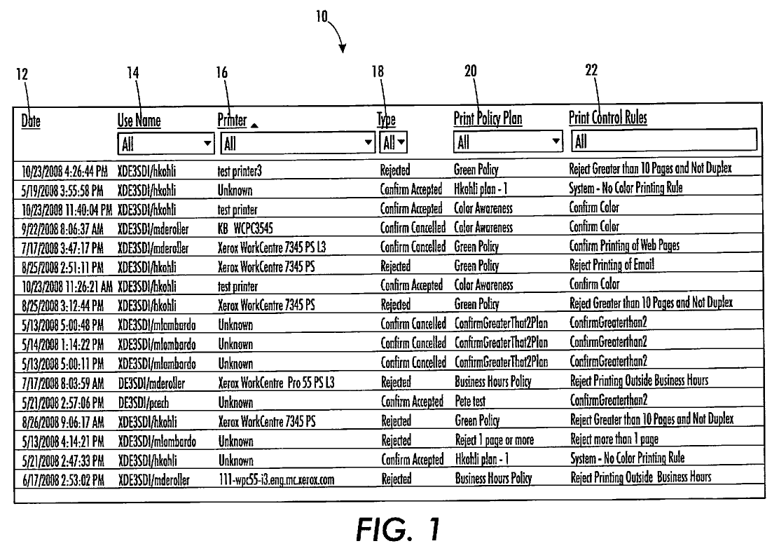

With reference to FIG. 1, there is presented a print policy log, in accordance with the present disclosure. The print log policy 10 includes several columns, such as, but not limited to, date 12, user name 14, printer 16, type 18, print policy plan 20, and print control rules 22.

FIG. 1 merely illustrates an example of a print log policy 10. These logs typically show date 12, user name 14, printer 16, document details, and print policy details. However, any type of desirable data may be displayed depending on the desired application. The print log policy 10 is a rich source of information as it documents attempted user printing behavior. Basically, every entry is an instance where a print policy and/or rule are enforced. This log 10 presents actual printing behavior, thus giving insight into how print governance policies and/or rules are being enforced, and user behavior associated with that activity.

In addition, a job tracking data module may be used to track attempted printing behavior and may include, but not limited to, print jobs, copy jobs, fax jobs, and/or scan jobs. One or more users may initiate such jobs from a plurality of MFDs. The output task jobs sent by the job tracking data module may be compared against the rules and/or policies located in an output governance rule module via an analyzing module.

The analyzing module may, for example, search for users not governed by the rules and/or policies located in the output governance rule module by comparing user names in job tracking data against output governance rules and/or policies. If a user name is not found, the analyzing module may flag the user or department currently not governed by any policy and/or rule located in the output governance rule module. In addition, the analyzing module may track whether the plurality of users are abiding by the rules and/or polices that were preset by the system administrator and also determine violators of such rules and/or policies.

The plurality of MFDs may send output task jobs via a network bus to the data tracking module. The data tracking module compares the data based on a rules engine and sends the comparison data to the analyzing module for further processing. The analyzing module determines, among other things, whether the plurality of users are abiding by the rules and/or polices preset by a system administrator.

Moreover, the information gathered (e.g., the attempted tasks) may be stored separately in a local or remote database for further processing. This may be a unique database designed solely for storing and analyzing such different types of data. Also, once a history of the rules and/or policies adhered to or violated is collected and stored for each of the plurality of MFDs, that history may be evaluated in the future for determining which rule and/or policy modifications achieved the best desired results for each MFD. In other words, the rule changes that took place (past changes) for each MFD may be stored and later compared against each other (for the same MFD) and ranked in order of best achieved results. The highest ranked rules for one MFD may be used in changing the rules and/or policies of other MFDs (future changes).

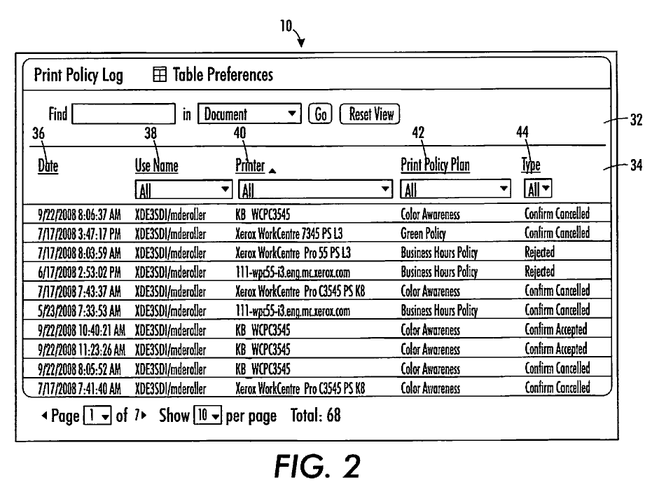

With reference to FIG. 2, there is presented a print policy log for a specific user, in accordance with the present disclosure. The specific print policy log 30 includes an input section 32 and a display section 34. The display section 34 includes several columns, such as, but not limited to, date 36, user name 38, printer 40, print policy plan 42, and type 44.

The specific log 30 illustrates every attempt, for example, user “mderoller” made to print, where a print governance policy and/or rule was enforced. As mentioned, this specific log 30 illustrates attempted printing activity. In some cases print jobs didn't actually succeed because they were rejected. A report such as this could be sent to the user periodically (e.g., daily/weekly/monthly basis).

This gives the user insight into his or her printing activity and conditions his or her printing behavior in, for example, two ways: (1) The user becomes more self-conscious, meaning that the user knows and understands that his or her attempted printing behavior is being monitored/tracked, and thus the user becomes more self-conscious of his printing, and less likely to attempt printing that goes against printing policy. As an example, the specific log 30 shows attempted printing during non-business hours. The user now sees this activity was logged, and the user's natural response is to not attempt it again, unless it was for valid business reasons. (2) The user has greater awareness of color usage meaning that the user may not realize how much color he or she is printing. The specific log 30 indicates many attempts to print color. The user may not be aware how many color copies are printed and thus how much color ink is consumed, and thus, uses it because it's available, even though he or she may not need it in every case. All this data/information may be tracked with the use of a data tracing module and analyzed with a data analyzing module in accordance with a data bank of rules and/or policies, such as a rules engine.

In general, the components of the job tracking system capture the specifications of every output task job, evaluate business rules and/or policies in the context of the output task job, evaluate end-user profile and behavioral history, interact with the end user to provide advice or direction related to the job, and record the user's response. All information related to each rule-processing transaction is uploaded or saved to a database or server. The server may be a local server or a remote server.

For example, the process may proceed as follows. The data tracking module tracks and monitors the print queues on the plurality of MFDs for the arrival of new print jobs (or any other type of output task jobs). When data tracking module detects a new output task job, it notifies the rules engine, which queries the print queue of the plurality of MFDs for the print job's specifications (e.g., user name, MFD name, MFD location, etc). The data tracking module includes detecting such information as the number of copies and pages to be printed, whether the job is to be printed in color, and other details which may be pertinent. The data tracking module describes the document to be printed and the printer settings requested by the end-user. The data tracking module gathers such information for every output task job and transmits such information to the results database for storage. The rules engine also queries the data tracking module for information about the user and his or her past printing behavior, referred to herein as the user's “usage history.”

The rules engine evaluates the rules and/or policies after comparing them to the data collected from the data tracking module, user profile, MFD profile, and usage history, thus obtaining a set of candidate rules for execution. The rules engine then evaluates the rules and/or policies on this set of candidate rules and the situation, and further filters and/or prioritizes the rules and/or policies. Finally, the rules engine selects one or more rules and/or polices to execute, by evaluating a final-selection rules and/or policies. In other words, the rules engine has the option of selecting one rule or more than one rule to compare against the data collected from the data tracking module. The rule selection process may be based on the user name, the MFD name, the user location, the MFD location, usage history of user, usage history of MFD, access times, printing requirements, size of output job, paper requirements, and/or priority of the rule or policy. The rule selection process may also be based on statistical comparison data, as for example, rules based on patterns generated from one or more collected, tracked, and analyzed data. These statistical techniques may enable enforcement of corporate policies/rules concerning what types of traffic are acceptable or permissible by users.

The rules engine sends a description of the actions to be performed, as specified by the selected rule and/or policy, to the analyzing module. Actions may include displaying the output task job's cost, advising the user on more cost-effective alternatives, or requiring the user to enter a charge code or cancel and resubmit the job in a preferred configuration, or combinations of such actions. The system administrator may also evaluate the data for compliance with preset rules and/or policies. The system administrator may look through the print governance logs in order to determine who the violators of the rules and/or polices are, and to modify the rules based on user printing behavior and suggest or enforce new rules and/or policies. If a rule is deemed violated, the system can either directly notify the user or notify a system administrator and provide alternative strategies to pursue regarding rejected attempted tasks. Additionally, the analyzed information pertaining to the plurality of users optionally informs a system administrator of the plurality of MFDs and the plurality of users that record levels of highest compliance and lowest compliance.

Moreover, the rules and/or principles may be modified and/or updated by an authorized user or by a plurality of authorized users at any desirable time for any of the plurality of MFDs (dynamic or real-time updating or rules). In other words, an authorized user may modify all the rules or a portion of the rules for only one MFD or for a group of MFDs or for all MFDs. Thus, certain MFDs may have different rules than other MFDs based on their usage, geographical location, and/or user access requirements even though such MFDs may be located in a single location or be part of the same group of MFDs.

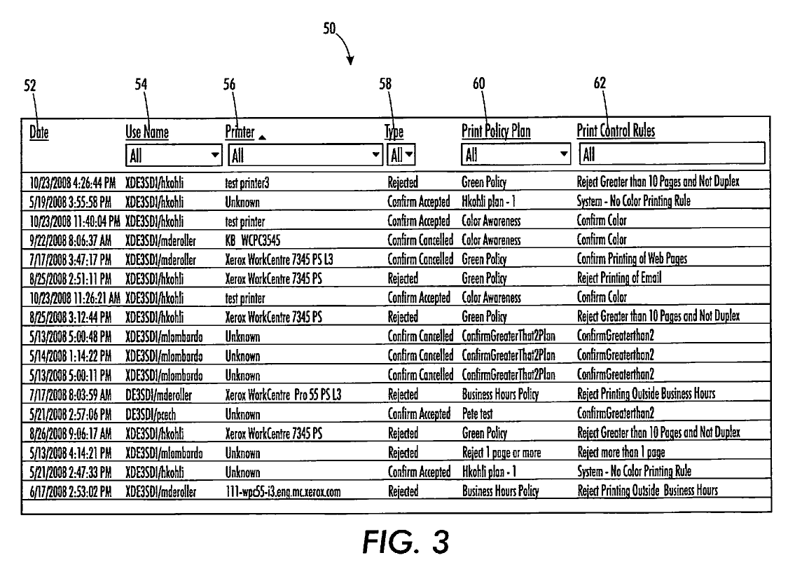

With reference to FIG. 3, there is presented a print policy log submitted to a system administrator for evaluation, in accordance with the present disclosure. The print policy log 50 includes several columns of information, such as, but not limited to, date 52, user name 54, printer 56, type 58, print policy plan 60, and print control rules 62.

The print governance log 50 is a rich source of information for system administrators as well. FIG. 2 illustrates activity for print policies and/or rules. One can target print governance log data for a particular policy and/or rule, in order to determine the pattern for enforcement over time. Ideally, a system administrator would like to see rule enforcement drop over time. This means that users have become accustomed to the policy and/or rule, and have modified their printing behavior accordingly.

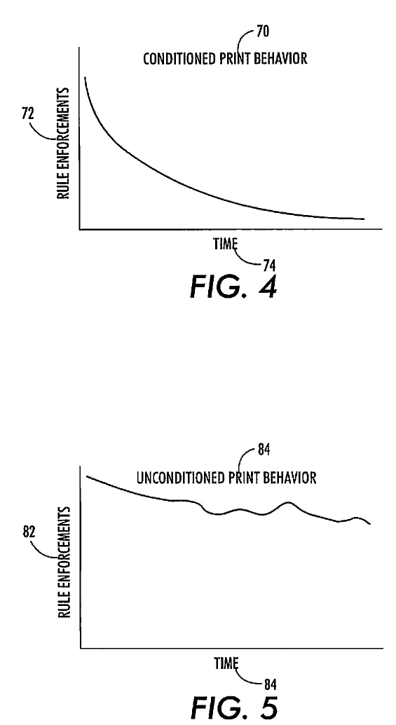

With reference to FIG. 4, there is presented a conditioned print behavior plot, in accordance with the present disclosure. The plot 70 is a conditioned print behavior plot, where the x-axis represents time 74 and the y-axis represents rule enforcements 72.

The data in FIG. 4 may be gathered from the print governance log 50 of FIG. 3. The plot 70 illustrates the desired print behavior and gives the system administrator confidence that this particular policy and/or rule may not be causing user frustration, or loss of user productivity. A plot, such as the one shown in FIG. 4, may be derived for each rule and/or policy. A number of rules and/or polices may be contemplated by one skilled in the art.

In general, regarding the rules and/or policies contemplated, the output governance rules and/or policies are configured in the output management software for the governance of at least printing, copying, faxing, and scanning in the enterprise. These rules and/or policies are often associated with an MFD or groups of MFDs. They can be configured to control printing at the user level (groups of users in departments). In large-scale deployments, configuration and management of these rules and/or policies can be a very complex task. However, the exemplary embodiments of the present disclosure allow for ease of data flow and efficient operation through the use of rules and/or policies designed specifically for users and MFDs. Several different rules and/or polices may be created that are related to interaction between MFDs and users of those MFDs.

One example of a rule could be the conversion of specific internal reports from a one-sided format and print device to a double-sided format and print device. This reduces paper costs by 50%. A code could offer a number of optimization routines in which a project manager determines which ones are relevant for his/her entity. Theoretically, code could offer the option to define the maximum print and/or copier budget in a given month for each or selected user.

Another example of a rule could be that each MFD may be operated in accordance with a particular set of rules. By way of example, if a user has reached his weekly quota of copies, the MFD may be disabled for that user. Also, if someone is trying to make too many copies on a low volume MFD, he/she is told to move to a higher-volume MFD. Another rule may be if it is a weekend, then color copying is disabled from one or more or all MFDs.

Moreover, in certain networks or environments, rules and/or polices may be contemplated where MFDs may be organized into logical groups of various levels. Users of one group may be restricted from using MFDs in a different group depending on use permissions or access rights, for example. Each user is assigned a set of access levels. For instance, a member of the executive group may have access to any of the company MFDs worldwide, and administrative group member may only have access to local MFDs, and a member of the apprentice group may only have permission to do black and white copying. As a result, rules and/or policies may be formed that apply to specific groups of MFDs. In other words, each MFD or group of MFDs may have a different set of rules and/or policies depending on a variety of factors, such as level of authority within an entity. Therefore, any type of rules and/or policies may be contemplated in any type of configuration related to any number of users and/or MFDs in any type of networking environment.

With reference to FIG. 5, there is presented an unconditioned print behavior plot, in accordance with the present disclosure. The plot 80 is an unconditioned print behavior plot, where the x-axis represents time 84 and the y-axis represents rule enforcements 82.

The data in FIG. 5 may be gathered from the print governance log 50 of FIG. 3. The plot 80 illustrates undesired print behavior. A plot, such as the one shown in FIG. 5, may be derived for each rule and/or policy. A number of rules and/or polices may be contemplated by one skilled in the art.

As shown in FIG. 5, rule enforcement has not dropped significantly for this particular policy and/or rule. This could indicate a number of things to the system administrator, such as: (1) the policy and/or rule itself is too strict and is causing user frustration and potential loss of productivity, (2) alternative print devices with less strict policies and/or rules may not be available or known to these users, and/or (3) this may also be causing an unusually high number of help desk tickets, as users are reporting problems with their printing environment. The system administrator can then take action from this data, perhaps modifying the problematic print policy and/or rule, or ensuring suitable alternative print devices are available to the plurality of users.

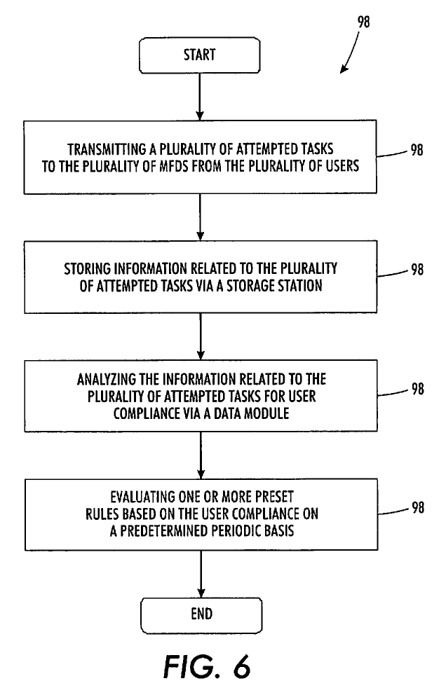

With reference to FIG. 6, there is illustrated a method for monitoring usage behaviors of a plurality of users and analyzing user compliance for evaluation of one or more preset rules and/or policies, in accordance with the present disclosure.

The flowchart 90 illustrates a method for monitoring usage behaviors of a plurality of users and analyzing user compliance for evaluation of one or more preset rules and/or policies. In step 92, a plurality of attempted tasks are transmitted to the plurality of MFDs from the plurality of users. In step 94, information related to the plurality of attempted tasks is stored in a storage station. In step 96, the information related to the plurality of attempted tasks for user compliance are analyzed with a data module. In step 98, one or more preset rules are evaluated based on user compliance on a predetermined periodic basis.

Generally, the exemplary embodiments of the present disclosure have the following benefits of efficient gap checking, including allowing the managed print services provider to identify potential gaps in print governance well before the customer sees the data. The provider can then make changes to the policies/rules in place to correct the problem, by evaluating and analyzing the compliance in relation to the rules and/or policies themselves.

Moreover, deploying output management solutions to large-scale enterprise environments requires diligence and skill on the part of the administrators who configure and monitor these tools. In cases where these solutions are deployed as part of a managed services agreement, the service provider has guaranteed a cost savings to the customer. It's important that these output management solutions are managed correctly, to ensure effective print governance. Any gaps in governance could result in missed cost savings. Thus, in an alternative embodiment, management and monitoring of print governance could be made easier and more effective with the introduction of automatic print governance alerting.

The present disclosure further proposes the use of alerts tied to print governance activities. For example, an alert can be configured for any print policy or rule within a policy. In addition, one or more thresholds can be set to trigger alerts and/or alerts can be sent immediately or grouped hourly, daily, weekly or monthly and/or alerts can be delivered via electronic means (e.g., email, cell phone, etc.) and/or logged to an external file.

The benefits of introducing automatic print governance alerts may include: (1) The administrator can be proactively notified of print governance activity, (2) The administrator doesn't have to sort through potentially thousands of log entries to identify/characterize print governance activity, (3) New policies can be monitored more closely, targeted monitoring to ensure effectiveness, and (4) Potential problems with print infrastructure can be discerned. For example, relating to benefit (4), a sudden spike in alerts for a particular policy could indicate a recent unauthorized configuration change to a policy, or a broken printer is causing a shift in print activity. Thus, this alternative embodiment of the present disclosure allows a user to target specific print governance activity with automatic alerts (automatic print governance alerting).

It is further contemplated that any software that governs printing in an enterprise environment by using print policies and rules can leverage this aspect of the present disclosure (i.e., automatic print governance alerting). For example, for each print governance policy, alerts can be created. The alert may be a notification to the administrator(s) of activity related to the policy, or specifically any rule in the policy. Additionally, the administrator(s) of the output management software may select the policies or rules within the policies for which they'd like to enable alerts.

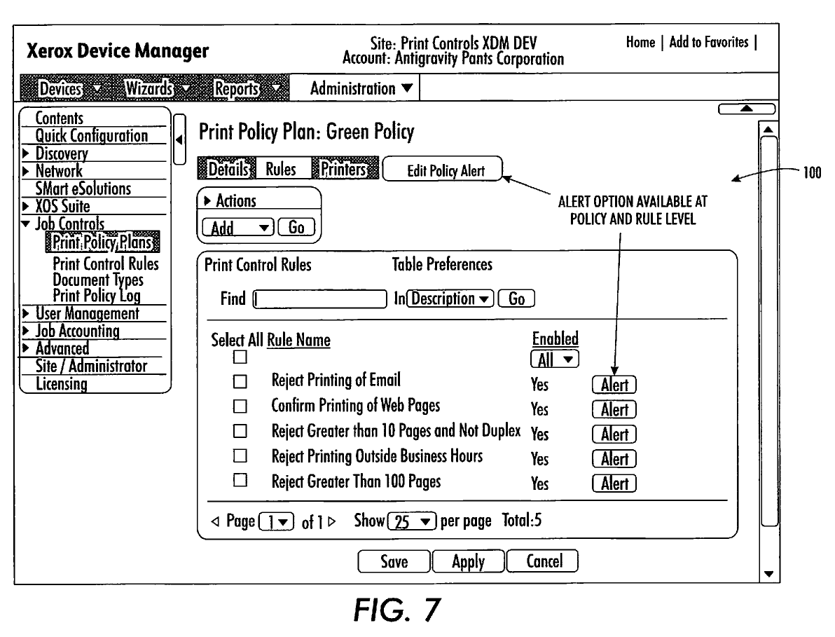

Referring to FIG. 7, one or more alerts may be displayed on a screen 100 next to the rule or policy and the administrator(s) may be enabled to select a “edit policy alert” button on a display screen to edit/modify a rule and/or policy. Furthermore, the alerts may be visual alerts or audible alerts and may be transmitted to a user/administrator via any type of electronic means and may be logged (e.g., lists of alert histories). FIG. 7 shows an example of a user interface 100 that illustrates how an alert option may be enabled, in accordance with the present disclosure.

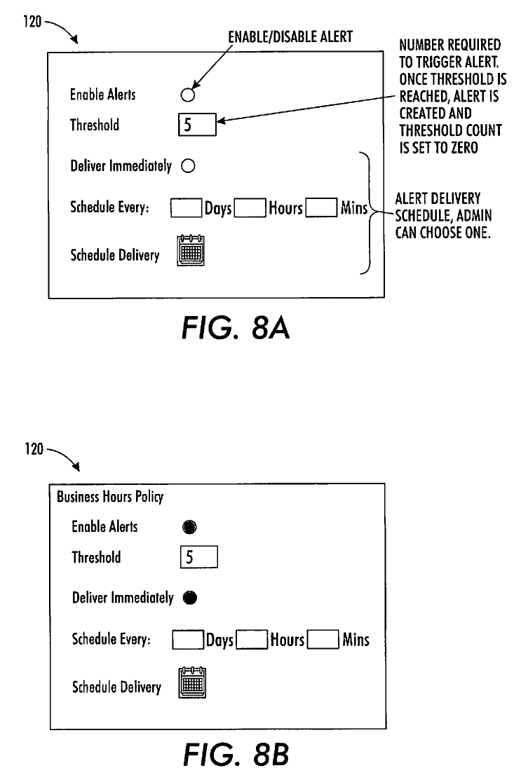

Referring to FIG. 8A an alert editing screen 110 is illustrated, in accordance with the present disclosure. Once an administrator chooses to create a policy or rule alert, the administrator may then select the options for the alert. The options may include, but are not limited to, an enable alerts button, a threshold entry, a deliver immediately button, a schedule alert entry, and a schedule delivery display.

Referring to FIG. 8B a business hours policy alert screen 120 is illustrated, in accordance with the present disclosure. This alert is configured to be triggered after 5 occurrences. However, a trigger may be set for any number of occurrences. Once the alert is triggered, it is sent via electronic means (e.g., email, cell phone, etc.) to the configured recipient. Typically, the recipients are the configured administrators of the output management software.

As a result, the alternative embodiment of the present disclosure proposes an automated print monitoring system composed of three components: (1) A set of rules, (2) a set of thresholds for the rules and (3) a collection of notification methods. The rules identify events that are of interest and should be monitored. The thresholds specify when an administrator needs to be notified about a rule being triggered. The notification methods specify how to contact an administrator. This exemplary system provides a flexible method of at least capturing information on print jobs, monitoring print usage patterns, validating conformance to policy and the ensuring correctness of policy.

The present disclosure proposes an alternative method that takes advantage of governance rules based on data tracking capabilities and based on analyzing user compliance to directly evaluate the rules and/or policies themselves. The approaches described above provide any service provider with several approaches for tracking data, modifying data, and utilizing governance rules and/or policies. Furthermore, the concept of applying governance rules and/or policies to data received from a plurality of MFDs is a general concept in that it can be used for any type of applications contemplated by one skilled in the art. For example, any service provider could provide/control/own/sell the MFDs. In addition, service providers could use any type of printer and/or MFD and/or electronic device to achieve the desired results of the present disclosure. Also the printing system of the present disclosure makes it easier for information technology (IT) groups and/or service providers to manage the printing environment for their clients.

A service provider can be any entity that develops, offers, controls, manages, owns, alters and/or sells software and/or hardware products. A service provider can be any entity that performs one or more tasks on one or more pre-existing MFDs, which may or may not be controlled or owned by the service provider. For example, the entity can offer a service with an existing software package and/or with any type of existing Internet-based service through the Internet. In other words, a service provider need not own or provide the MFDs. The MFDs may be owned or provided by any third party not related or associated with the service provider. In the present disclosure, it is contemplated that the entity (such as a service provider) can offer any type of service and/or product to optimize pre-existing, pre-owned MFDs by referring potential customers to an Internet website or a store that may or may not be associated with printing-related services and/or products. The term “entity” can refer to anything that may exist as a discrete and/or distinct unit that owns, operates, manages, and/or controls one or more of a plurality of machines (such as MFDs). For example, the term “entity” may include the term “company.”

In summary, the exemplary embodiments of the present disclosure leverage data that is already collected by most output management solutions in the market today, in a way that's unique and useful by providing a system and method for monitoring usage behaviors of a plurality of users and analyzing user compliance for evaluation of one or more preset rules and/or policies. Further advantages and benefits of the present disclosure are: (1) Allows administrators to be proactive in identifying potential problems with print governance policies and/or rules, (2) Conditions user printing behavior by making them self-conscious of their printing habits, and gives them insight into which printing features they use most (color in particular), they may rethink their use of color next time if it's not absolutely necessary, and (3) Reduces calls to the help desk for printing related problems.

Moreover, in accordance with the exemplary embodiments, customers are able to reduce or recover the cost of printing with minimal effort to set up and administer a system. Customers will be able to measure the true costs of printing on all the MFDs connected to or attempting to connect to the system. Customers will also be able to implement print policies and/or rules for cost reduction and charge-out at the point of print decision-making. Customers will also be able to easily set up the system and configure the system to their desired specifications since the system automatically discovers MFDs and users accessing the system. Customers may also purchase a system that includes a set of preset or predetermined defaults rules and/or policies that may be modified in any desirable manner based on cost reduction goals, cost recovery goals, and/or green initiatives. Customers will further be able to measure, understand, and gain control over the costs and environmental impact of printing in the organization by analyzing print volumes and usage by department, organization, and/or location. Additionally, customers will be able to accomplish print management objectives with minimal risk to any IT infrastructure and will be able to use rules and/or policies to prevent end-user complaints by enabling the system administrator to tune how often a user sees a message, relative to the user's compliance level. Finally, new users may be trained on print rules and policies as they do their work and progress through the organization and analytic reports will enable the system administrator to gauge rules' effectiveness on target user groups.

Additionally, customers gain the ability to manage their fleet of MFDs and reduce their entity's print costs significantly by rerouting their output to more cost effective MFDs. In addition, end users' productivity is virtually interruption free due to the predictive and proactive service of their MFDs, as well as the automated replenishment of supplies. Office equipment dealers are able to capture untapped office desktop print volume by either rerouting customers' output to their MFDs or by offering alternative sources for supplies and service for these desktop print devices.

The present disclosure also includes as an additional embodiment a computer-readable medium which stores programmable instructions configured for being executed by at least one processor for performing the methods described herein according to the present disclosure. The computer-readable medium can include flash memory, CD-ROM, a hard drive, etc.

It will be appreciated that variations of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

What is claimed is:

1. A printer management system suitable for monitoring usage behaviors of a plurality of users, the usage behaviors related to a plurality of multifunction devices (MFDs), the system comprising:
a storage station for storing information related to a plurality of attempted tasks transmitted to the plurality of MFDs by the plurality of users; and
a processor module for analyzing, at selected time intervals, the information related to the plurality of attempted tasks for user compliance to evaluate one or more preset rules based on the user compliance, said analyzing including automatic print governance alerting, where one or more alerts are configured to be triggered for any of the one or more preset rules.

2. The system according to claim 1, wherein the monitoring of the usage behaviors includes monitoring of one or more of the following: printing, copying, scanning, and faxing.

3. The system according to claim 1, wherein the analyzed information pertaining to a user of the plurality of users is sent directly to the user to indicate at least the one or more preset rules complied with and the one or more preset rules not complied with.

4. The system according to claim 1, wherein the analyzed information pertaining to the plurality of users is sent to a system administrator to determine which of the one or more preset rules are adhered to by the plurality of users and which of the one or more preset rules are not adhered to and require modification by the system administrator.

5. The system according to claim 4, wherein the system administrator modifies the one or more preset rules on a real-time basis based on real-time compliance or non-compliance information received.

6. The system according to claim 1, wherein the analyzed information pertaining to a user of the plurality of users optionally informs the user of one or more acceptable alternative strategies to pursue regarding rejected attempted tasks.

7. The system according to claim 1, wherein the analyzed information pertaining to the plurality of users optionally informs a system administrator of the plurality of MFDs and the plurality of users that record levels of highest compliance and lowest compliance.

8. A method suitable for suitable for monitoring usage behaviors of a plurality of users, the usage behaviors related to a plurality of multifunction devices (MFDs), the method comprising:
transmitting a plurality of attempted tasks to the plurality of MFDs from the plurality of users;
storing information related to the plurality of attempted tasks via a storage station;
analyzing, at selected time intervals, the information related to the plurality of attempted tasks for user compliance via a processor module; and
evaluating one or more preset rules based on the user compliance, the analyzing including automatic print governance alerting, where one or more alerts are configured to be triggered for any of the one or more preset rules.

9. The method according to claim 8, wherein the monitoring of the usage behaviors includes monitoring of one or more of the following: printing, copying, scanning, and faxing.

10. The method according to claim 8, wherein the analyzed information pertaining to a user of the plurality of users is sent directly to the user to indicate at least the one or more preset rules complied with and the one or more preset rules not complied with.

11. The method according to claim 8, wherein the analyzed information pertaining to the plurality of users is sent to a system administrator to determine which of the one or more preset rules are adhered to by the plurality of users and which of the one or more preset rules are not adhered to and require modification by the system administrator.

12. The method according to claim 11, wherein the system administrator modifies the one or more preset rules on a real-time basis based on real-time compliance or non-compliance information received.

13. The method according to claim 8, wherein the analyzed information pertaining to a user of the plurality of users optionally informs the user of one or more acceptable alternative strategies to pursue regarding rejected attempted tasks.

14. The method according to claim 8, wherein the analyzed information pertaining to the plurality of users optionally informs a system administrator of the plurality of MFDs and the plurality of users that record levels of highest compliance and lowest compliance.

15. A computer-readable medium storing programmable instructions configured for being executed by at least one processor for monitoring usage behaviors of a plurality of users, the usage behaviors related to a plurality of multifunction devices (MFDs), the method comprising:
transmitting a plurality of attempted tasks to the plurality of MFDs from the plurality of users;
storing information related to the plurality of attempted tasks via a storage station;
analyzing, at selected time intervals, the information related to the plurality of attempted tasks for user compliance via a processor module; and
evaluating one or more preset rules based on the user compliance, the analyzing including automatic print governance alerting, where one or more alerts are configured to be triggered for any of the one or more preset rules.

16. The computer-readable medium according to claim 15, wherein the monitoring of the usage behaviors includes monitoring of one or more of the following: printing, copying, scanning, and faxing.

17. The computer-readable medium according to claim 15, wherein the analyzed information pertaining to a user of the plurality of users is sent directly to the user to indicate at least the one or more preset rules complied with and the one or more preset rules not complied with.

18. The computer-readable medium according to claim 15, wherein the analyzed information pertaining to the plurality of users is sent to a system administrator to determine which of the one or more preset rules are adhered to by the plurality of users and which of the one or more preset rules are not adhered to and require modification by the system administrator.

19. The computer-readable medium according to claim 18, wherein the system administrator modifies the one or more preset rules on a real-time basis based on real-time compliance or non-compliance information received.

20. The computer-readable medium according to claim 15, wherein the analyzed information pertaining to a user of the plurality of users optionally informs the user of one or more acceptable alternative strategies to pursue regarding rejected attempted tasks.

21. The computer-readable medium according to claim 15, wherein the analyzed information pertaining to the plurality of users optionally informs a system administrator of the plurality of MFDs and the plurality of users that record levels of highest compliance and lowest compliance.

22. The computer-readable medium according to claim 15, wherein the analyzing of the information includes automatic print governance alerting, where one or more alerts are configured to be triggered for any of the one or more preset rules.

23. A system for monitoring usage behaviors of a plurality of users, the usage behaviors related to a plurality of multifunction devices (MFDs), the system comprising:
a computing device;
a computer-readable storage medium in communication with the computing device, the computer-readable storage medium comprising one or more programming instructions for:
transmitting a plurality of attempted tasks to the plurality of MFDs from the plurality of users;
storing information related to the plurality of attempted tasks via a storage station;
analyzing the information related to the plurality of attempted tasks for user compliance via a data module;
evaluating one or more preset rules based on the user compliance on a predetermined periodic basis; and
automatically providing print governance alerting, where one or more alerts are configured to be triggered for any of the one or more preset rules.
